(19) United States
(12) Patent Application Publication
(10) Pub. No.: US 2024/0422249 A1
(43) Pub. Date: Dec. 19, 2024

(54) ADVANCED DRIVER ASSISTANCE SYSTEM AND INTER-CORE COMMUNICATION DEVICE

(71) Applicant: Black Sesame Technologies Co., Ltd., Wuhan (CN)

(72) Inventor: Ting Du, Chengdu (CN)

(73) Assignee: Black Sesame Technologies Co., Ltd., Wuhan (CN)

(21) Appl. No.: 18/741,670

(22) Filed: Jun. 12, 2024

(30) Foreign Application Priority Data
Jun. 13, 2023 (CN) 202310706227.7

(51) Int. Cl. H04L 69/22; H04L 69/08

(52) U.S. Cl. CPC H04L 69/22; H04L 69/08

(57) ABSTRACT

An advanced driver assistance system and an inter-core communication device are provided. The inter-core communication device includes an original file layer, a bottom tool layer and an upper tool layer. The original file layer includes an IPC communication interface, a Franca IDL file, a Franca specification file and a Franca definition file. The Franca IDL file is used to describe an interface definition language file of the IPC communication interface. The Franca specification file is used to declare a target communication interface and attributes of the target communication interface. The Franca definition file is adapted for defining the Franca IDL file. The bottom tool layer is adapted for generating a first model object, a second model object and a third model object. The upper tool layer is adapted for generating a target communication interface between a target client and a target server.

### RELATED APPLICATION

This application claims the benefit under 35 U.S.C. § 119 (a) of the filing date of Chinese Patent Application No. 202310706227.7, filed in the Chinese Patent Office on Jun. 13, 2023. The disclosure of the foregoing application is herein incorporated by reference in its entirety.

### TECHNICAL FIELD

The present disclosure generally relates to intelligent driving technology field, and more particularly, to an advanced driver assistance system and an inter-core communication device.

### BACKGROUND

With the development of autonomous driving technology, the types and number of sensors applied on vehicles continuously increase, such as lidar, millimeter-wave radar, front-view cameras, rear-view cameras, etc. As a result, the amount of data that needs to be transmitted and processed also greatly increases. Computing power can be increased by increasing the number of Electronic Control Units (ECUs), thereby improving a data processing speed and data processing efficiency. Inter-core communication plays an important role between different Electronic Control Units.

In conventional technology, in order to realize inter-core communication, a driver layer and a middleware are encapsulated to provide an interface for transmitting data frames. Developers encapsulate data that needs to be transmitted into data frames and use the interface for data transmission.

However, data that needs to be transmitted has different types, lengths and transmission methods, and thus corresponding data frames need to be generated, leading to low development efficiency.

### SUMMARY

The present disclosure provides a solution for improving development efficiency of inter-core communication.

According to some embodiments of the present disclosure, an inter-core communication device is provided. The inter-core communication device includes an original file layer, a bottom tool layer and an upper tool layer. The original file layer includes an IPC communication interface, a Franca Interface Definition Language (IDL) file, a Franca specification file and a Franca definition file. The Franca IDL file is used to describe an interface definition language file of the IPC communication interface. The Franca specification file is used to declare a target communication interface and attributes of the target communication interface, and the attributes of the target communication interface include a type and an identification of a target client, a type and an identification of a target server, a type and an identification of a function, a type and an identification of a broadcast, and a type of a prefix setting flag bit. The Franca definition file is adapted for defining the Franca IDL file, and is used to set the identification of the target client and the identification of the target server, assign a one-to-one corresponding identification to each broadcast and function respectively, and set the prefix setting flag bit. The bottom tool layer is adapted for parsing the Franca IDL file and generating a first model object corresponding to the Franca IDL file, parsing the Franca specification file and generating a second model object corresponding to the Franca specification file, and parsing the Franca definition file and generating a third model object corresponding to the Franca definition file. The upper tool layer is adapted for generating the target communication interface between the target client and the target server based on the IPC communication interface, the first model object, the second model object and the third model object. The target communication interface connects the target client and the target server, and includes a broadcast communication interface corresponding to the broadcast and a message communication interface corresponding to the function.

According to some embodiments, when the prefix setting flag bit is true, customized attributes in the Franca definition file include a package name and a version number.

According to some embodiments, the bottom tool layer includes an IDL parser and a deployment language parser. The IDL parser is adapted for parsing the Franca IDL file to obtain elements in the Franca IDL file, and generating the first model object based on the elements in the Franca IDL file. The deployment language parser is adapted for parsing the Franca specification file to obtain the second model object, and the second model object includes: a designation of the identification of the target client and a declaration of the type of the target client, a designation of the identification of the target server and a declaration of the type of the target server, a designation of the prefix setting flag bit and a declaration of the type of the prefix setting flag bit, a designation of the identification of the broadcast and a declaration of the type of the broadcast, and a designation of the function and a declaration of the type of the function. The deployment language parser is adapted for parsing the Franca definition file to obtain the third model object, and the third model object includes: attributes in the first model object that match items defined in the Franca definition file, attributes in the second model object that match items defined in the Franca definition file, a definition of the identification of the target client, a definition of the identification of the target server, a definition of the identification of the broadcast, and a definition of the identification of the function.

According to some embodiments, the upper tool layer is adapted for converting a data type of the first model object into a data type corresponding to the target communication interface, converting a customized data type into a data type corresponding to the target communication interface, converting the broadcast into the broadcast communication interface, and converting the function into the message communication interface.

According to some embodiments, the broadcast communication interface includes a target client-side broadcast communication interface and a target server-side broadcast communication interface. The target client-side broadcast communication interface includes a broadcast subscription interface and a broadcast callback function registration interface. The broadcast subscription interface is adapted for subscribing to a broadcast message. The broadcast callback function registration interface is adapted for registering a callback function used for processing the broadcast message when the broadcast message is received. The target server-side broadcast communication interface is used for sending the broadcast messages.

According to some embodiments, the message communication interface includes a target client-side communication interface and a target server-side communication interface. The target client-side communication interface includes an asynchronous communication interface, a synchronous communication interface and a no-message-reply interface. The asynchronous communication interface includes an asynchronous call registration interface, an asynchronous call callback function registration interface and an asynchronous call interface. The asynchronous call registration interface is used to encapsulate input parameters into a message data frame. The asynchronous call callback function registration interface is used to register a callback function corresponding to the asynchronous call interface. The asynchronous call interface is used to trigger an asynchronous call and send the message data frame to the target server. The synchronous communication interface includes a synchronous call interface which is used to encapsulate input parameters into a message data frame and send the message data frame to the target server. The no-message-reply interface is used to encapsulate input parameters into a message data frame and send the message data frame to the target server. The target server-side communication interface includes a message processing interface which is used for processing asynchronous and synchronous messages sent by the target client, and messages sent through the no-message-reply interface from the target client.

According to some embodiments, the IPC communication interface is encapsulated in the target communication interface.

According to some embodiments, the inter-core communication device further includes a model layer used for storing the first model object, the second model object and the third model object.

According to some embodiments, the inter-core communication device further includes an interface layer which includes the target communication interface.

According to some embodiments, an advanced driver assistance system is also provided. The advanced driver assistance system includes: a target client, a target server, and the inter-core communication device according to any one of aforementioned embodiments.

Compared with the conventional technology, embodiments of the present disclosure may have following advantages.

In the original file layer, the IPC communication interface, the Franca IDL file, the Franca specification file and the Franca definition file are configured, the corresponding first model object, second model object and third model object are generated by the bottom tool layer, and the target communication interface corresponding to the target client and the target server is generated by the upper tool layer. Since the Franca IDL interface is not limited by operating system platforms and has diversified application scenarios, the Franca specification file and the Franca definition file can be configured by developers with high flexibility, the target communication interface can be automatically generated by the upper tool layer to achieve inter-core communication.

### BRIEF DESCRIPTION OF THE DRAWINGS

FIG. 1 schematically illustrates a structural diagram of an inter-core communication device according to some embodiments of the present disclosure.

### DETAILED DESCRIPTION

Franca is a framework for defining and transforming software APIs, at the core of which is a Franca IDL. The Franca IDL is a text API specification language with which developers can define an interface, and the interface may contain definitions of constants, variables, data types, functions, broadcasts, and so on. The interface defined by the Franca IDL can be converted into a Franca model, can be converted into an interface defined by other IDL interface description languages, or can be converted into a desired interface through a customized generator.

The Franca IDL is an interface definition language with no target generation language restrictions and no platform restrictions, and provides basic morphology and grammatical structures required for communication.

An advanced driver assistance system is an active safety technology. The advanced driver assistance system utilizes various sensors installed in a vehicle to collect environmental data inside and outside the vehicle in the first time, and performs technical processing such as identification, detection and tracking of dynamic and static objects, which enables a driver to be aware of possible dangers in the shortest time, thereby drawing attention to the driver and improving safety.

In the conventional technology, an inter-core communication mechanism applied to ADAS is not provided with a flexible and configurable interface. For different types, lengths, and transmission modes of transmitted data, developers need to perform unpacking and packing operations on messages by themselves, which results in low development efficiency.

According to embodiments of the present disclosure, a Franca IDL interface is not limited by operating system platforms and has diversified application scenarios. A Franca specification file and a Franca definition file can be configured by developers with high flexibility, and a target communication interface can be automatically generated by an upper tool layer to achieve inter-core communication.

In order to clarify the object, solutions and advantages of embodiments of the present disclosure, embodiments of present disclosure will be described clearly in detail in conjunction with accompanying FIGURES.

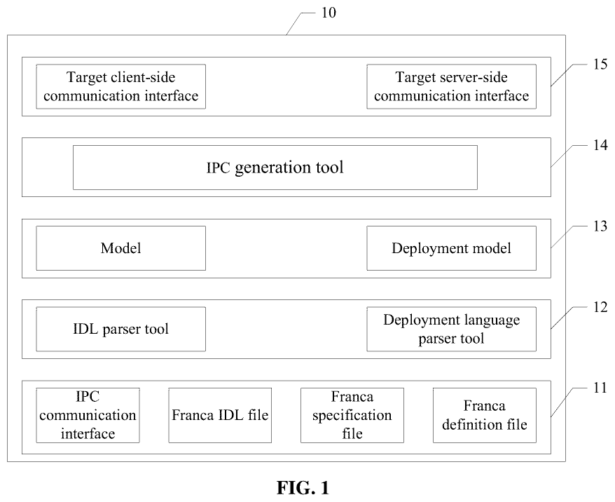

Some embodiments of the present disclosure provide an inter-core communication device 10. Referring to FIG. 1, the inter-core communication device 10 includes an original file layer 11, a bottom tool layer 12, and an upper tool layer 14.

According to some embodiments, the original file layer 11 includes a Franca IDL file, a Franca specification file, a Franca definition file, and an IPC communication interface.

In specific applications, the IPC communication interface may be an original interface used between a target client and a target server, and may include a synchronous communication interface, an asynchronous communication interface, a broadcast communication interface, and the like. Data is transmitted by the IPC communication interface in the form of data frames.

The Franca IDL file, also referred to as fidl, is an interface definition language file used to describe a communication interface. The Franca IDL file includes a content which includes definitions of a package name, an imported fidl, a version number, an interface, a type collection, a constant, a variable (attribute), a customized data type (user type), a function (method), a broadcast and so on.

In a process of generating the Franca IDL file, it is necessary to clarify the content and method of communication messages between the target client and the target server. In other words, the content in the Franca IDL file is associated with the content and method of communication messages between the target client and the target server.

Specifically, if synchronous communication, asynchronous communication, and no-message-reply communication between the target client and the target server are required, a function (method) needs to be defined accordingly. If broadcast communication is required, a broadcast needs to be defined accordingly. If a complex data type exists, a customized data type (user type) needs to be defined.

The customized data type may be a data type other than a basic data type. The basic data type may include an integer type, a floating point type, and a byte buffer type (equivalent to a pointer). Therefore, a basis is provided for transmitting diverse types of data by setting the customized data type.

It should be understood that developers can configure the content in the Franca IDL file according to actual requirements of the communication between the target client and the target server.

According to some embodiments, the Franca specification file may be used to declare a target communication interface and unique attributes within the target communication interface.

According to some embodiments of the present disclosure, the unique attributes within the target communication interface may be defined to include: both a server type and a client type being an integer type, used for subsequently setting a kernel identification (ID) of the target server and a kernel identification (ID) of the target client; a prefix setting flag bit being defined as a Boolean type, used for indicating whether to generate a customized attribute containing a package name and a version number, where the version number is a version of a relevant software running on both the target client and the target server; and ID of both a function (method) and a broadcast being an integer type, used for subsequently setting the ID of the function (method) and the ID of the broadcast.

According to some embodiments of the present disclosure, the target communication interface and unique attributes within the target communication interface may be defined through the Franca definition file. In other words, the unique attributes of a specific Franca IDL file may be defined through the Franca definition file based on the attributes declared in the Franca specification file (such as the unique attributes within the target communication interface mentioned above).

That is to say, the target communication interface and the unique attributes within the target communication interface are declared through the Franca specification file, and defined through the Franca definition file.

According to some embodiments, the Franca specification file and the Franca IDL file configured with the above-mentioned unique attributes may be imported into the Franca definition file. A kernel ID corresponding to the target server and the kernel ID corresponding to the target client are set through the Franca definition file, and applied to all broadcasts and functions (methods) under a current target communication interface. The Franca definition file sets the prefix setting flag bit to be true or false. When the prefix setting flag bit is true, all customized attributes generate a prefix with a package name and a version number. An ID value is assigned to each function (method) and each broadcast through the Franca definition file, and used for one-to-one communication between the target client and the target server.

According to some embodiments, the bottom tool layer 12 includes an IDL parser tool and a deployment language parser tool.

According to some embodiments, the IDL parser tool is a parser for a fidl file, and used for identifying elements (items) in the fidl file and storing the elements (items) into a model object.

According to some embodiments, the deployment language parser tool is a parser used for parsing the Franca specification file and the Franca definition file. First, the Franca definition file is parsed. Then, based on defined elements (items), the Franca specification file is checked to determine if there are corresponding configuration items. Additionally, the imported fidl file is checked to determine if there are corresponding attributes. If the attributes match, the configuration items are stored into a deployment model.

According to some embodiments, the inter-core communication device 10 may also include a model layer 13. The model layer 13 may include a plurality of model objects generated by the bottom tool layer 12 based on the original file layer 11. Each model object includes parsing results of one or more interfaces or type collections.

The upper tool layer 14 includes an IPC generation tool. The IPC generation tool can design different generators based on the model objects in the model layer, such as a document generator, a library generator, and some communication-related generators.

According to some embodiments, the model layer 13 may include a model and the deployment model.

According to some embodiments, the model includes a list of model objects generated by the IDL parser tool based on fidl file. The number of the model objects is determined by the number of import ports contained in a fidl file, that is, dependent upon a number of other fidl files that are imported into the fidl file. One fidl file corresponds to generation of one model object, and one model object contains at least one interface item or type collection item.

According to some embodiments, the deployment model may include a list of model objects generated by the deployment language parser tool based on the Franca specification file and the Franca definition file. One model object contains a parsing result of one Franca specification file, or a parsing result of one Franca definition file. Based on the model object generated by the Franca specification file and the Franca definition file, a generator may add an ID for inter-core communication to the generated interface, and the one-to-one unique ID for messages sent and received between the target client and the target server can ensure reliability of inter-core communication.

Specifically, the model objects generated based on the Franca specification file include: a designation of the ID and a declaration of a type of the ID of the target client and the target server; a designation of an attribute and a declaration of a type of a prefix; and a designation of the ID and a declaration of a type of the ID of a broadcast and a function (method).

The designation of the ID and the declaration of a type of the ID of the target client may refer to: the ID designated for the target client, and the type of the ID being an integer type. Correspondingly, the designation of the ID and the declaration of a type of the ID of the target server may refer to: the ID designated for the target server, and the type of the ID being an integer type.

Correspondingly, the designation of the ID and the declaration of a type of the ID of the broadcast and the function (method) may refer to: the ID designated for the broadcast, the type of the ID being an integer type, the ID designated for the function (method), and the type of the ID being an integer type.

The model objects generated based on the Franca definition file may include: an imported fidl file, an imported Franca specification file, a definition of the ID of the target client and the target server, and a definition of the ID of the broadcast and the function (method).

Based on items defined in the Franca definition file, the deployment language parser tool searches for corresponding attributes in the model generated by the fidl file and matches the corresponding attributes with the items defined in the Franca definition file, so as to add the attributes defined in the Franca definition file to the generated target client interface and target server interface. Based on items defined in the Franca definition file, the deployment language parser tool searches for a designation of corresponding attributes in the imported Franca specification file, and determines whether a type of the attributes matches.

According to some embodiments, the IPC generation tool may be a generator for an inter-core communication interface and designed based on the model layer, and may include the following functions.
1) The model objects can be converted into the basic data types in a target interface language.

For example, integer data in different lengths is converted into int64_t, int32_t, etc. respectively.
2) Customized data types can be converted into types in the target interface language.

For example, if the target interface language is C language or C++ language, customized struct and enum types can be converted into formats corresponding to C language or C++ language.
3) Based on a combination of the model and the deployment model, broadcasts in the Franca definition file can be converted into the broadcast communication interfaces between the target client and the target server. Each pair of broadcast communication interface has the same ID number, which is used for matching sent and received messages during broadcast communication. The client is a subscriber of the broadcasts, and the server is a sender of the broadcasts.
4) Based on a combination of the model and deployment model, functions (methods) in the Franca definition file can be converted into the message communication interfaces between the target client and the target server. Each pair of message communication interface has the same ID number, which is used for matching sent and received messages during communication. The target client is the sender of the messages, and the target server is the receiver of the messages.

Specifically, if a message is a synchronous message, a code segment of waiting for a reply to the message is added to a sending interface of the target client by the IPC generation tool. If a message is an asynchronous message, an independent callback function (method) interface is generated in the target client by the IPC generation tool. Whether the message is a synchronous message or an asynchronous message, it can be processed by the target server, and a message reply code segment used to reply to the message sent by the target client can be added.
5) In order to avoid interfaces of different versions calling each other and causing compile or runtime errors, declarations and definitions of generated prefixes or non-generated prefixes could be found in the Franca specification file and the Franca definition file. Since isolation between versions is provided by a namespace when generating C++ interfaces, a namespace for the versions is added to the upper tool layer 14 without adding a prefix to a customized attribute. In the C language, the interface can get a value of the prefix setting flag bit, if the value of the prefix setting flag bit is true, a prefix including a version number and a package name is generated, or if the value of the prefix setting flag bit is false, no prefix is generated.

According to some embodiments, the inter-core communication device 10 further includes an interface layer 15. The interface layer 15 may include: a target client-side communication interface and a target server-side communication interface, which are generated by the IPC generation tool in the upper tool layer 14 based on the model layer and the IPC communication interface in the original file layer 11. That is, the interface layer can be generated by the IPC generation tool based on the model layer and the IPC communication interface.

The IPC communication interface of the bottom file layer is encapsulated by the interface layer 15, and the transmitted data is exposed to an output parameter and input parameter of the communication interface, eliminating the need for unpacking and packing the transmitted data.

Specifically, the target client-side communication interface may include: an asynchronous communication interface, a synchronous communication interface, a no-message-reply communication interface, a broadcast communication interface, and the like.

The asynchronous communication interface may include: an asynchronous call registration interface, an asynchronous call callback function registration interface, and an asynchronous call interface.

According to some embodiments, the asynchronous call registration interface is used to encapsulate input parameters into a message data frame.

According to some embodiments, the asynchronous call callback function registration interface is used for asynchronously calling a callback function corresponding to the communication interface, and parameters of the callback function are output parameters of the corresponding interface in the fidl file.

According to some embodiments, the asynchronous call interface is used to trigger an asynchronous call and send the message data frame to the target server.

According to some embodiments, the synchronous communication interface may include a synchronous call interface. The synchronous call interface is used for encapsulating input parameters into a message data frame, sending the message data frame to the target server, waiting for a message response data frame returned by the target server, performing an unpacking operation on the message response data frame, and adding message response data into the input parameters.

According to some embodiments, the no-message-reply communication interface may include a no-message-reply interface which is used for encapsulating input parameters into a message data frame and sending the message data frame to the target server.

According to some embodiments, the broadcast communication interface may include: a broadcast subscription interface and a broadcast callback function registration interface.

According to some embodiments, the broadcast subscription interface is used for subscribing to broadcast messages.

According to some embodiments, the broadcast callback function registration interface is used for registering a callback function when receiving a broadcast message, and the callback function is used for processing the broadcast message.

According to some embodiments, the target server-side communication interface may include a message processing interface and a broadcast sending interface.

According to some embodiments, the message processing interface is used for processing asynchronous and synchronous messages sent by the target client, and messages sent by the target client through the no-message-reply interface. The target server unpacks and processes the data frames corresponding to the received asynchronous messages, adds a message reply code segment, packs the message for reply into a reply data frame, and sends the reply data frame to the target client through the message processing interface. The target client triggers the corresponding message callback function after receiving the reply data frame.

According to some embodiments, the broadcast sending interface is used for sending broadcast messages.

In summary, according to some embodiments of the present disclosure, since the Franca IDL interface is not limited by operating system platforms and has diversified application scenarios, the Franca specification file and the Franca definition file can be configured by developers with high flexibility, the target communication interface can be automatically generated by the upper tool layer to achieve inter-core communication.

Those skilled in the art may appreciate that all or some of the steps in the various methods of the aforementioned embodiments may be accomplished by instructing the relevant hardware through a program. The program may be stored in a computer-readable storage medium, which may include, for example, a ROM, a RAM, a disk, an optical disk and the like.

Although the present disclosure has been disclosed above with reference to preferred embodiments thereof, it should be understood that the disclosure is presented by way of example only, and not limitation. Those skilled in the art can modify and vary the embodiments without departing from the spirit and scope of the present disclosure. Therefore, the scope of the present disclosure shall be defined by the claims.

What is claimed is:

1. An inter-core communication device, comprising an original file layer, a bottom tool layer and an upper tool layer;
wherein the original file layer comprises an IPC communication interface, a Franca IDL file, a Franca specification file and a Franca definition file; the Franca IDL file is used to describe an interface definition language file of the IPC communication interface; the Franca specification file is used to declare a target communication interface and attributes of the target communication interface, and the attributes of the target communication interface comprise a type and an identification of a target client, a type and an identification of a target server, a type and an identification of a function, a type and an identification of a broadcast, and a type of a prefix setting flag bit; and the Franca definition file is adapted for defining the Franca IDL file, is used to set the identification of the target client and the identification of the target server, assign a one-to-one corresponding identification to each broadcast and function respectively, and set the prefix setting flag bit;
the bottom tool layer is adapted for parsing the Franca IDL file and generating a first model object corresponding to the Franca IDL file, parsing the Franca specification file and generating a second model object corresponding to the Franca specification file, and parsing the Franca definition file and generating a third model object corresponding to the Franca definition file; and
the upper tool layer is adapted for generating the target communication interface between the target client and the target server based on the IPC communication interface, the first model object, the second model object and the third model object; and the target communication interface connects the target client and the target server, and comprises a broadcast communication interface corresponding to the broadcast and a message communication interface corresponding to the function.

2. The inter-core communication device according to claim 1, wherein when the prefix setting flag bit is true, customized attributes in the Franca definition file comprise a package name and a version number.

3. The inter-core communication device according to claim 1, wherein the bottom tool layer comprises an IDL parser and a deployment language parser;
the IDL parser is adapted for parsing the Franca IDL file to obtain elements in the Franca IDL file, and generating the first model object based on the elements in the Franca IDL file;
the deployment language parser is adapted for parsing the Franca specification file to obtain the second model object, and the second model object comprises: a designation of the identification of the target client and a declaration of the type of the target client, a designation of the identification of the target server and a declaration of the type of the target server, a designation of the prefix setting flag bit and a declaration of the type of the prefix setting flag bit, a designation of the identification of the broadcast and a declaration of the type of the broadcast, and a designation of the function and a declaration of the type of the function; and
the deployment language parser is adapted for parsing the Franca definition file to obtain the third model object, and the third model object comprises: attributes in the first model object that match items defined in the Franca definition file, attributes in the second model object that match items defined in the Franca definition file, a definition of the identification of the target client, a definition of the identification of the target server, a definition of the identification of the broadcast, and a definition of the identification of the function.

4. The inter-core communication device according to claim 1, wherein the upper tool layer is adapted for converting a data type of the first model object into a data type corresponding to the target communication interface, converting a customized data type into a data type corresponding to the target communication interface, converting the broadcast into the broadcast communication interface, and converting the function into the message communication interface.

5. The inter-core communication device according to claim 1, wherein the broadcast communication interface comprises a target client-side broadcast communication interface and a target server-side broadcast communication interface;
the target client-side broadcast communication interface comprises a broadcast subscription interface and a broadcast callback function registration interface; the broadcast subscription interface is adapted for subscribing to a broadcast message; the broadcast callback function registration interface is adapted for registering a callback function used for processing the broadcast message when the broadcast message is received; and
the target server-side broadcast communication interface is used for sending the broadcast message.

6. The inter-core communication device according to claim 1, wherein the message communication interface comprises a target client-side communication interface and a target server-side communication interface;
the target client-side communication interface comprises an asynchronous communication interface, a synchronous communication interface and a no-message-reply interface;
the asynchronous communication interface comprises an asynchronous call registration interface, an asynchronous call callback function registration interface and an asynchronous call interface, wherein the asynchronous call registration interface is used to encapsulate input parameters into a message data frame, the asynchronous call callback function registration interface is used to register a callback function corresponding to the asynchronous call interface, and the asynchronous call interface is used to trigger an asynchronous call and send the message data frame to the target server;
the synchronous communication interface comprises a synchronous call interface which is used to encapsulate input parameters into a message data frame and send the message data frame to the target server;
the no-message-reply interface is used to encapsulate input parameters into a message data frame and send the message data frame to the target server; and
the target server-side communication interface comprises a message processing interface which is used for processing asynchronous and synchronous messages sent by the target client, and messages sent through the no-message-reply interface from the target client.

7. The inter-core communication device according to claim 1, wherein the IPC communication interface is encapsulated in the target communication interface.

8. The inter-core communication device according to claim 1, further comprising: a model layer used for storing the first model object, the second model object and the third model object.

9. The inter-core communication device according to claim 1, further comprising an interface layer which comprises the target communication interface.

10. An advanced driver assistance system, comprising: a target client, a target server, and an inter-core communication device; wherein the inter-core communication device comprises an original file layer, a bottom tool layer and an upper tool layer;
wherein the original file layer comprises an IPC communication interface, a Franca IDL file, a Franca specification file and a Franca definition file; the Franca IDL file is used to describe an interface definition language file of the IPC communication interface; the Franca specification file is used to declare a target communication interface and attributes of the target communication interface, and the attributes of the target communication interface comprise a type and an identification of a target client, a type and an identification of a target server, a type and an identification of a function, a type and an identification of a broadcast, and a type of a prefix setting flag bit; and the Franca definition file is adapted for defining the Franca IDL file, and is used to set the identification of the target client and the identification of the target server, assign a one-to-one corresponding identification to each broadcast and function respectively, and set the prefix setting flag bit;
the bottom tool layer is adapted for parsing the Franca IDL file and generating a first model object corresponding to the Franca IDL file, parsing the Franca specification file and generating a second model object corresponding to the Franca specification file, and parsing the Franca definition file and generating a third model object corresponding to the Franca definition file; and
the upper tool layer is adapted for generating the target communication interface between the target client and the target server based on the IPC communication interface, the first model object, the second model object and the third model object; and the target communication interface connects the target client and the target server, and comprises a broadcast communication interface corresponding to the broadcast and a message communication interface corresponding to the function.

11. The advanced driver assistance system according to claim 10, wherein when the prefix setting flag bit is true, customized attributes in the Franca definition file comprise a package name and a version number.

12. The advanced driver assistance system according to claim 10, wherein the bottom tool layer comprises an IDL parser and a deployment language parser;
the IDL parser is adapted for parsing the Franca IDL file to obtain elements in the Franca IDL file, and generating the first model object based on the elements in the Franca IDL file;
the deployment language parser is adapted for parsing the Franca specification file to obtain the second model object, and the second model object comprises: a designation of the identification of the target client and a declaration of the type of the target client, a designation of the identification of the target server and a declaration of the type of the target server, a designation of the prefix setting flag bit and a declaration of the type of the prefix setting flag bit, a designation of the identification of the broadcast and a declaration of the type of the broadcast, and a designation of the function and a declaration of the type of the function; and
the deployment language parser is adapted for parsing the Franca definition file to obtain the third model object, and the third model object comprises: attributes in the first model object that match items defined in the Franca definition file, attributes in the second model object that match items defined in the Franca definition file, a definition of the identification of the target client, a definition of the identification of the target server, a definition of the identification of the broadcast, and a definition of the identification of the function.

13. The advanced driver assistance system according to claim 10, wherein the upper tool layer is adapted for converting a data type of the first model object into a data type corresponding to the target communication interface, converting a customized data type into a data type corresponding to the target communication interface, converting the broadcast into the broadcast communication interface, and converting the function into the message communication interface.

14. The advanced driver assistance system according to claim 10, wherein the broadcast communication interface comprises a target client-side broadcast communication interface and a target server-side broadcast communication interface;
the target client-side broadcast communication interface comprises a broadcast subscription interface and a broadcast callback function registration interface; the broadcast subscription interface is adapted for subscribing to a broadcast message; the broadcast callback function registration interface is adapted for registering a callback function used for processing the broadcast message when the broadcast message is received; and
the target server-side broadcast communication interface is used for sending the broadcast message.

15. The advanced driver assistance system according to claim 10, wherein the message communication interface comprises a target client-side communication interface and a target server-side communication interface;
the target client-side communication interface comprises an asynchronous communication interface, a synchronous communication interface and a no-message-reply interface;
the asynchronous communication interface comprises an asynchronous call registration interface, an asynchronous call callback function registration interface and an asynchronous call interface, wherein the asynchronous call registration interface is used to encapsulate input parameters into a message data frame, the asynchronous call callback function registration interface is used to register a callback function corresponding to the asynchronous call interface, and the asynchronous call interface is used to trigger an asynchronous call and send the message data frame to the target server;
the synchronous communication interface comprises a synchronous call interface which is used to encapsulate input parameters into a message data frame and send the message data frame to the target server;
the no-message-reply interface is used to encapsulate input parameters into a message data frame and send the message data frame to the target server; and
the target server-side communication interface comprises a message processing interface which is used for processing asynchronous and synchronous messages sent by the target client, and messages sent through the no-message-reply interface from the target client.

16. The advanced driver assistance system according to claim 10, wherein the IPC communication interface is encapsulated in the target communication interface.

17. The advanced driver assistance system according to claim 10, wherein the inter-core communication device further comprises: a model layer used for storing the first model object, the second model object and the third model object.

18. The advanced driver assistance system according to claim 10, wherein the inter-core communication device further comprises an interface layer which comprises the target communication interface.
